(19) United States
(12) Patent Application Publication
(10) Pub. No.: US 2014/0369481 A1
(43) Pub. Date: Dec. 18, 2014

(54) IMAGE COMMUNICATION APPARATUS, METHOD OF CONTROLLING THE SAME, AND STORAGE MEDIUM

(71) Applicant: CANON KABUSHIKI KAISHA, TOKYO (JP)

(72) Inventors: Yosui NAITO, Kawasaki-shi (JP); Daisuke SUGA, Kawasaki-shi (JP); Michio FUKUSHIMA, Yokohama-shi (JP); Eiji OHARA, Kawasaki-shi (JP); Shigeru KOIZUMI, Tokyo (JP)

(21) Appl. No.: 14/295,539

(22) Filed: Jun. 4, 2014

(30) Foreign Application Priority Data
Jun. 18, 2013 (JP) 2013-127985

(51) Int. Cl. H04N 1/327

(52) U.S. Cl. CPC H04N 1/32708
USPC 379/100.16

(57) ABSTRACT

An image communication apparatus capable of performing calls/facsimiles via an IP network, and equipped with at least two modems and an SLIC that connects a telephone, determines whether an establishment of a session is possible when an INVITE signal, for which a media type is audio, is received. The apparatus controls so that in an automatic reception mode, when it is determined that an establishment of a session is possible, a usable modem is selected from the modems, and treated as audio communication is performed using that selected modem, and also so that when it is determined that the establishment of a session is possible, it is determined whether the SLIC is in use, and when it is not in use, a call of the telephone is performed by the SLIC.

### BACKGROUND OF THE INVENTION

1. Field of the Invention

The present invention relates to an image communication apparatus for performing calls and facsimile communication via a communication network such as an IP network, to a method of controlling the same, and to a storage medium.

2. Description of the Related Art

In recent years, due to the spread of the Internet and IP telephones, approaches for using an IP network as a communication path for FAX communication have been established. Also, a call control protocol called SIP (Session Initiation Protocol) for performing the generation, the modification, and the disconnection of a session for real-time communication has been standardized.

The T.38 protocol for performing real-time transmission of G3 FAX (T.30) signals over an IP network by converting them into IP messages has been recommended, and Internet facsimile apparatuses compliant with T.38 have come to be sold. Also, “treated as audio communication” (also known as “in-band communication”), in which modem signal tones are treated as audio, converted to PCM data, and communication of them as audio packets is performed over an IP network, is starting to spread. This “treated as audio communication” is also called FoIP (FAX over Internet Protocol).

FAX communication according to the T.38 protocol has the advantages that bandwidth can be small compared to “treated as audio communication” which requires a voice frequency band, and that because it is not necessary to modulate the data into modem signals, high speed communication can be performed. On the other hand, “treated as audio communication” has the advantage that communication is possible with a G3 FAX apparatus on an analog telephone network connected to an IP network via a VoIP GW (Gateway).

In addition, on an IP network, it is possible to generate a plurality of sessions simultaneously, and to perform multiple communications in parallel. Regarding internal IP networks, from before multi-session contracts have been possible in NGNs (Next Generation Network), services of which NTT, a telephone company within the country of Japan, provides.

As a technology for realizing an IP telephone apparatus, there is an SLIC (Subscriber Line Interface Circuit) module. Such an SLIC performs analog-digital conversion processing by an audio CODEC such as G.711, telephone line emulation, and the like. With the SLIC, it is possible to connect an analog telephone apparatus to the IP network without going through a telephone line, and a function of simulating a telephone line, wherein call signals of a telephone line (switching equipment), and various tone signals are generated, can be provided. Note, in a case of an incoming audio call, a media type of a session establishment request (an INVITE signal) is “audio”, and in a case of T.38, the media type is “application” or “image”. Using this, determination is made that there is audio communication when an INVITE signal having a media type of “audio” is received from a transmission side, and a ringer of an analog telephone apparatus can be caused to sound by the SLIC generating a call signal. Here, when a user on a receiving side responds with the analog telephone apparatus, the SLIC detects an off-hook of the analog telephone apparatus, stops the call signal, and transmits a success response (200 OK) to the transmitter side. With this, when the transmission side returns an ACK, the audio session is established, and a call state is entered.

In a case where an IP telephone function is supported by the Internet facsimile apparatus, there is a need for realization using an IP telephone of incoming call control other than the receiving mode that was performed conventionally by analog FAX apparatuses. There are mainly four receiving modes, which are automatic reception, manual reception, FAX/TEL switching, and away TEL connection. “automatic reception” is a receiving mode in which upon an incoming call, an MFP automatically responds and performs fax reception. Depending on the MFP, sounding/non-sounding settings for when an incoming call is received can be performed, and in a case of a sounding setting, configuration is such that the telephone apparatus is made to sound a number of times in order to notify the user of the incoming call even in automatic reception mode. “manual reception” is a mode in which upon an incoming call, the user is called by sounding a slave telephone apparatus, and by the user pressing a reception start key after performing an off-hook with the slave telephone apparatus, fax reception is performed. “FAX/TEL switching” is a mode in which in a case where it is determined that the partner device is a FAX by detecting a calling signal (CNG signal), while calling the user by sounding the slave telephone apparatus in order to call the user upon an incoming call, the call is aborted and fax reception is initiated. “away TEL connection” is a mode used in a case where a slave telephone apparatus having an answering machine function is connected to the MFP. Upon an incoming call, the slave telephone apparatus is called, and configuration is taken such that the slave telephone apparatus is able to respond automatically. This is a mode in which, fax reception is performed if it is determined that there is a fax reception by detecting a CNG signal while the slave telephone apparatus is responding automatically.

In a case where an Internet facsimile apparatus supports multiple sessions, there are cases where initiation requests for a plurality of sessions are received simultaneously. However, in many cases the number of slave telephone apparatuses connected to the apparatus is normally one, and it is envisioned that there is one SLIC for controlling that. In these kinds of configurations, there is a need for realization of incoming call control modes different for each receiving mode considering multiple sessions.

Japanese Patent Laid-Open No. 2011-114672 discloses a technique for controlling an incoming ring of an IP telephone. In Japanese Patent Laid-Open No. 2011-114672, in a telephone network, an incoming call tone is not sounded immediately when an incoming call is received by an automatic voice response. In the automatic response, an authentication tone obtained by superposing random numbers subjected to random number processing each time and background tone is notified as the authentication tone required for connection to a transmitter for each connection, an incoming ring is sounded only for incoming calls in which a correct response value is received, and the incoming ring is not performed for incoming calls for which this is not the case.

Japanese Patent Laid-Open No. 2008-205617 discloses a call connection control method according to SIP for a case in which a call connection request message is received from a second apparatus in the middle of a call connection being executed having received of a call connection request message from a first apparatus. In such a case, call control for the second apparatus is executed after the call control with the first apparatus ends, and after the call connection is established, data communication is performed in parallel.

In this conventional example, it is not described in particular about the control of operation upon an incoming call corresponding to multiple sessions of an IP telephone function and a FAX communication function.

In general communication apparatuses, because there is only one SLIC, in a case where audio INVITE signals, for which there is the possibility that there is a call objective, are received simultaneously for two sessions, performing incoming call control in accordance with a receiving mode is a problem. For example, in a case where the SLIC is being used by the first session, if reply is always made with a busy response in a case where the INVITE signal of the second session is audio, FoIP reception of the second session cannot be performed in a case of automatic reception mode. Conversely, if, in a case where the SLIC is being used by the first session, and the INVITE signal of the second session is audio, a session establishment response is sent in reply, in spite of the fact that the IP telephone cannot be used in the case of manual reception mode, a session establishment response will be performed.

### SUMMARY OF THE INVENTION

An aspect of the present invention is to eliminate the above-mentioned problems which are found in the conventional technology.

A feature of the present invention is to provide a technique in which incoming call control is performed in accordance with a receiving mode in a case where audio INVITE signals are received for a plurality of sessions

According to an aspect of the present invention, there is provided an image communication apparatus capable of performing a call and a facsimile communication via an IP network. The apparatus comprises at least two modems, an SLIC that connects a telephone apparatus, a determination unit configured to determine whether or not an establishment of a session is possible when an INVITE signal, for which a media type is audio, is received and a control unit configured to control so that in an automatic reception mode, when the determination unit determines that the establishment of a session is possible, a usable modem is selected from out of the at least two modems, and treated as audio communication is performed using the selected modem, and so that when the determination unit determines that the establishment of a session is possible, it is determined whether or not the SLIC is in use, and when the SLIC is not in use, a call of the telephone apparatus is performed by the SLIC.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining a hardware configuration of a multi function peripheral (MFP) according to embodiments of the present invention, and a communication network including that MFP.

FIG. 2 is a flowchart for describing automatic reception processing in the MFP according to a first embodiment.

FIG. 3 is a flowchart for describing manual reception processing in the MFP according to the first embodiment.

FIGS. 4A and 4B are a flowchart for describing FAX/telephone switching processing in the MFP according to the first embodiment.

FIG. 5 is a flowchart for describing reception processing in a case where a receiving mode of the MFP according to the first embodiment is a mode for connecting to an answering machine.

FIG. 6 is a timing chart for explaining a timing of a synchronized serial transfer of PCM data.

FIG. 7 is a flowchart for describing processing of the subroutine executed immediately after initiation of FoIP communication of step S410 in the MFP according to a second embodiment.

### DESCRIPTION OF THE EMBODIMENTS

Embodiments of the present invention will be described hereinafter in detail, with reference to the accompanying drawings. It is to be understood that the following embodiments are not intended to limit the scope of the claims of the present invention, and that not all of the combinations of the aspects that are described according to the following embodiments are necessarily required with respect to the means to solve the problems according to the present invention.

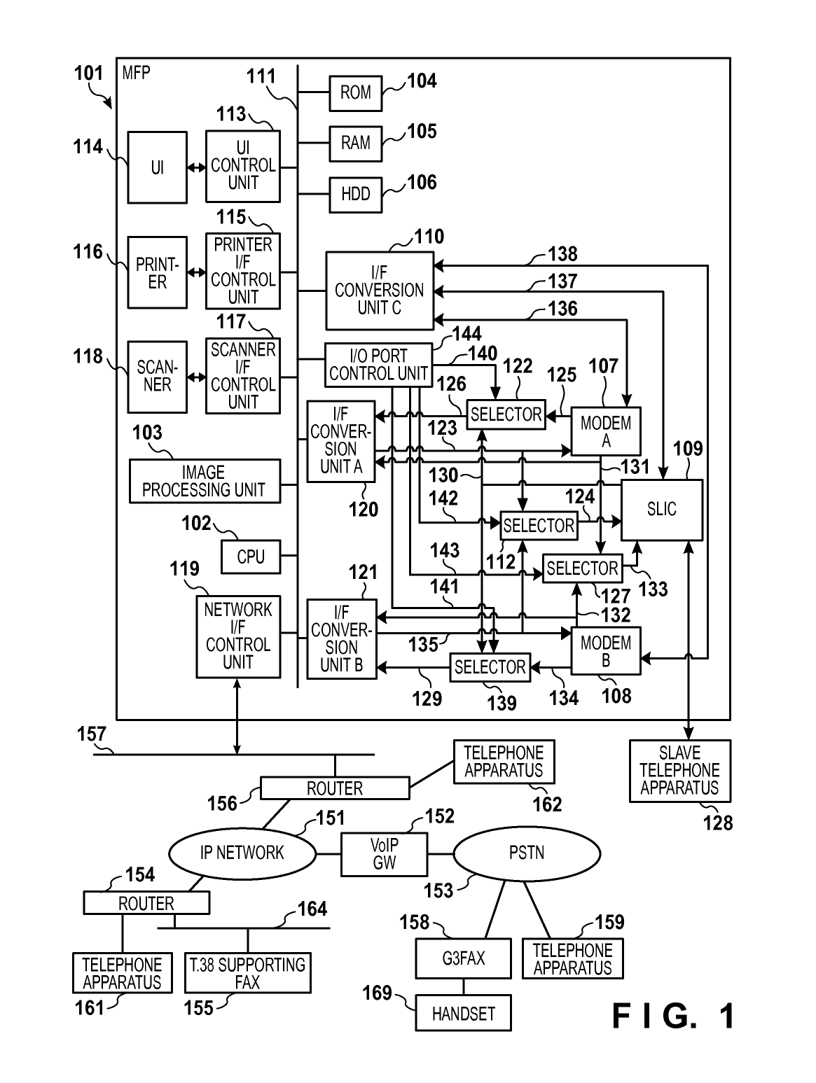

FIG. 1 is a block diagram for explaining a hardware configuration of a multi function peripheral (MFP: Multi Function Peripheral) 101 according to embodiments of the present invention, and a communication network including that MFP 101.

In this embodiment, explanation of an image communication apparatus is made with the multi function peripheral 101 comprising an Internet facsimile communication function, and an incoming call control mode is proposed for a case where the multi function peripheral 101 has multiple sessions and IP telephone functions.

Note, as a premise, an upper limit value on the number of sessions simultaneously generatable is made to be “2”, and two modems 107 and 108 have a digital input/output function and a PCM codec built into in order to perform FoIP communication simultaneously for two communications, and a single SLIC 109 is provided for IP telephone control.

Briefly explanation will be given for the modems having the digital input/output functions. Normal modems are units that modulate digital data, convert it into analog audio, and output that to an analog telephone network, and conversely demodulate analog audio received from an analog telephone network, and convert that into digital data. In the present embodiment, the modems having the digital input/output functions are able to output audio, for which digital data to be transmitted is modulated, digitally converted into PCM data by a PCM codec. Also, “treated as audio communication” PCM data received from an IP network can be converted into analog audio by a PCM codec, that analog audio can be demodulated, and the digital data can be obtained. Hereinafter, the modems 107 and 108 according to embodiments indicate modems having this digital input/output function.

The MFP 101 is connected to an IP network 151 via a LAN (Local Area Network) 157 and an analog port included router 156. Regarding the IP network 151, a network including a gateway for connecting reciprocally the Internet and an NGN, or the like, a DNS (Domain Name Server) for performing name resolution, a SIP server, or the like is assumed. A T.38 supporting FAX 155 having a T.38 supporting FAX function is connected to the IP network 151 via a LAN 164 and an analog port included router 154. To the analog ports of the analog port included routers 154 and 156, telephone apparatuses 161 and 162 for PSTN connection are connected respectively, and each telephone apparatus is capable of calling the other telephone apparatus via the routers. Note, within the country of Japan, the analog port included routers may use an HGW (Home GateWay) that a telephone company supplies. In addition, the analog port included routers 154 and 156 may be routers without analog ports. However, in such a case, the telephone apparatuses 161 and 162 for PSTN connection cannot be used.

A SIP (Session Initiation Protocol) server (not shown) within the IP network 151 performs SIP session connection processing. In addition, between the IP network 151 and a public switched telephone network (PSTN) exists a VoIP GW (gateway) 152 for performing data transfer processing. A G3 FAX 158 is a facsimile terminal corresponding to T.30 audio communication only. A handset 169 is connected to a terminal for a telephone apparatus of the G3 FAX 158, and is used for calling when performing manual reception, manual transmission or the like, by the G3 FAX 158. A telephone apparatus 159 is connected to the PSTN 153, and is a telephone apparatus capable of calling another telephone apparatus.

Next, explanation will be given for the MFP 101.

The MFP 101 has an image data input/output function, scans a paper document with a scanner 118, and inputs the image data, and prints onto paper with a printer 116. Also, the MFP 101 is able to print onto paper based on input image data, save as digital data, and transfer to another device via a LAN, a FAX, or the like. The MFP 101 is persistently connected to the LAN 157, and is able to receive, and print onto a sheet, print data from a PC (not shown) via the LAN 157, or image data from another MFP. In addition, a user is able to instruct an operation to the MFP 101 via a user interface (hereinafter referred to as UI) 114.

The MFP 101 is connected to a commercial power supply, and operation is performed with electric power being supplied to within the MFP 101 from a power supply circuit (not shown). A bus 111 connects a scanner I/F control unit 117, a CPU 102, a ROM 104, a RAM 105, an HDD 106, a printer I/F control unit 115, a UI control unit 113, an image processing unit 103, and a network I/F control unit 119, and data can be transmitted between these. In addition, the bus 111 connects an I/F converting unit A120, an I/F converting unit B121, an I/F converting unit C110, and an I/O port control unit 144. The bus 111 is a system bus over which control signals, address signals, and the like are transmitted from the CPU 102, and over which data signals, and the like, are transmitted between each of the units.

The CPU 102 reads control programs of the MFP 101 from the ROM 104 or the HDD 106, loads these into the RAM 105, and executes them, and controls overall operations of the MFP 101. The ROM 104 stores a boot program of the MFP 101, fixed parameters, or the like, and includes flash memory, for example. However, the ROM 104 is not limited to flash memory, and may be another type of memory. The RAM 105 is used as a loading area of programs, and for storage, or the like, of temporary work data, image data, or the like, when the CPU 102 controls the MFP 101. The HDD 106 is used for storage, or the like, of image data, print data, and destination information, and for storage of various data. In addition, the RAM 105, the HDD 106, or the like, are used as work areas for the CPU 102 to perform work of image processing corresponding to image data, encoding/decoding, resolution conversion, or the like. Also, the RAM 105, the HDD 106, or the like, are used as work areas for performing work for encoding, decoding, or the like, of data that the CPU 102 transfers, and for IP packet processing. The image processing unit 103 is a hardware circuit for performing image processing for image quality enhancing of image data, resolution conversion, encoding, decoding, or the like.

The UI control unit 113 controls the user interface (UI) 114, displays various information to the UI 114 and inputs instructions from a user via the UI 114. The printer I/F control unit 115 controls the printer 116. The scanner I/F control unit 117 controls the scanner 118. The network I/F control unit 119 controls data transmission and receiving with the LAN 157, and performs analysis, generation, and the like of IP packets such as TCP, UDP, RTP packets, or the like. Data transmitted or received by transmission and receiving of an IP packet is interpreted by the CPU 102 after being first saved in the RAM 105, the HDD 106, or the like, and is processed in accordance with protocol stipulations. In addition, the MFP 101 is able to perform call connection with a partner device using a SIP session, and data communication and audio communication via the network I/F control unit 119 and the IP network 151.

Also, the CPU 102 receives VoIP packets from the IP network 151 via the network I/F control unit 119, and analyzes them, and transfers retrieved PCM (Pulse Code Modulation) data to the I/F converting unit A120, the I/F converting unit B121, or the like. VoIP is an abbreviation of Voice over Internet Protocol. In addition, the CPU 102 generates VoIP packets from PCM data retrieved from the I/F converting unit A120, the I/F converting unit B121, or the like, and transfers these to the IP network 151 via the network I/F control unit 119. FAX communication by performing modulation and demodulation by a modem using this VoIP packet PCM data is called communication by “treated as audio”. The modems (modulation and demodulation apparatuses) are used for data transmission, protocol control, or the like, of FAX communication by modulating/demodulating audio signals based on an ITU-T recommendation. This PCM data is transferred to the SLIC 109 from the I/F converting unit A120, the I/F converting unit B121, or the like, and is used for audio calls by a slave telephone apparatus 128, FAX transmission and reception by the modem A107 or the modem B108, or the like.

The I/F converting unit A120 and the I/F converting unit B121 perform interface conversion for performing data transmission and receiving by adapting PCM data for exchange between the modem A107, the modem B108, and the SLIC 109 with data on the bus 111. In general, the I/F converting unit A120 and the I/F converting unit B121 have buffers, and perform buffering processing collectively so that PCM data received from the IP network 151, and PCM data received from the modems A107 and B108, the SLIC 109, or the like, as much as possible does not have discontinuations. The I/F converting unit A120, the I/F converting unit B121, the modem A107, the modem B108, the SLIC 109, a selector 112, a selector 122, a selector (first selector) 127, and a selector 139 are connected as shown in FIG. 1, and are capable of transmission and reception of PCM data. Note, the first selector 127, the second selectors 122 and 139, and the third selector 112 select one of a plurality of input signals in accordance with a control signal supplied from the CPU 102 via the I/O port control unit 144, and output it.

Next, explanation will be given for signal connection.

A modem A transmission PCM signal 125 transmitted from the modem A107 and an SLIC transmission PCM signal 130 transmitted from the SLIC 109 are input into the selector 122. Here, by the CPU 102 controlling the selector 122 via the I/O port control unit 144, one of the signals is supplied to the I/F converting unit A120 from the selector 122 as a transmission PCM signal A126. Each of the I/O port control unit 144, and the selectors 122, 112, 139 and 127 is connected by a selector control signal 140, a selector control signal 142, a selector control signal 141, and a selector control signal 143. Accordingly, the CPU 102 is able to perform switching of the signal that these selectors select via the I/O port control unit 144.

PCM data received from the IP network 151 is transmitted to the I/F converting unit A120 or the I/F converting unit B121. Here, in a case where PCM data received from the IP network 151 is sent to the I/F converting unit A120, the PCM data received from the IP network 151 is supplied to the modem A107 and the selector 112 from the I/F converting unit A120 as a reception PCM signal A123.

In addition, in a case where the PCM data received from the IP network 151 is sent to the I/F converting unit B121, the PCM data received from the IP network 151 is supplied to the modem B108 and the selector 112 from the I/F converting unit B121 as a reception PCM signal B135. Then, by the CPU 102 controlling switching of the selector 112 via the I/O port control unit 144, one of the reception PCM signal A123 and the reception PCM signal B135 is supplied to the SLIC 109 from the selector 112 as an SLIC reception PCM signal 124.

A modem B transmission PCM signal 134 output from the modem B108 and the SLIC transmission PCM signal 130 output from the SLIC 109 are input to the selector 139. The CPU 102 controls switching of the selector 139 via the I/O port control unit 144. With this, one of the signals of the modem B transmission PCM signal 134 and the SLIC transmission PCM signal 130 is supplied to the I/F converting unit B121 from the selector 139 as a transmission PCM signal B129.

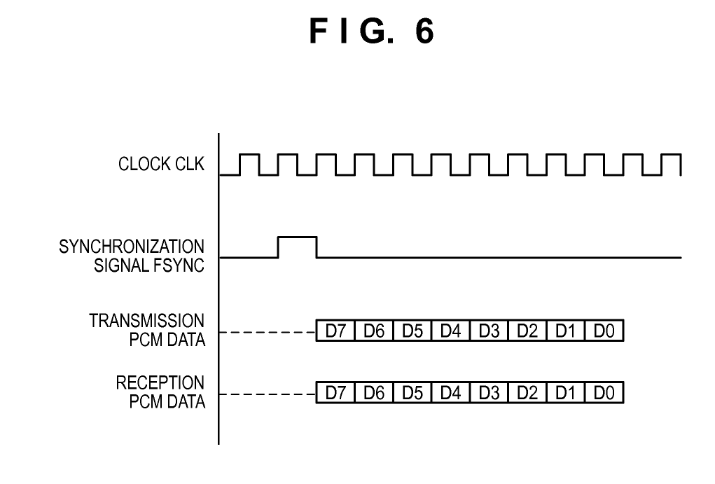

FIG. 6 is a timing chart for explaining a timing of a synchronized serial transfer of PCM data.

In FIG. 6, the timing of the signals of four lines in total, the two timing signals of a clock CLK, and a synchronization signal FSYNC, and two data signals of transmission PCM data, and reception PCM data are shown. The clock CLK and the synchronization signal FSYNC correspond to a modem A output synchronization signal 131 and a modem B output synchronization signal 132 of FIG. 1 respectively.

The modem A output synchronization signal 131 is supplied to the I/F converting unit A120 and the selector 127 from the modem A107. In addition the modem B output synchronization signal 132 from the modem B108 is supplied to the I/F converting unit B121 and the selector 127. By the CPU 102 controlling the switching of the selector 127 via the I/O port control unit 144, one of the modem A output synchronization signal 131 and the modem B output synchronization signal 132 is supplied to the SLIC 109 from the selector 127 as an output synchronization signal 133.

In this way, the clock CLK and the synchronization signal FSYNC are sent from the modems to the SLIC 109, the I/F converting unit, or the like, and the clock CLK and the synchronization signal FSYNC, as timing signals, keep synchronization of the transmission PCM data and the reception PCM data.

Next, explanation will be given for a case in which a PCM data transfer is performed by the modem A107 and the I/F converting unit A120.

The reception PCM signal A123 output from the I/F converting unit A120 and input into the modem A107 is reception PCM data. In addition the modem A transmission PCM signal 125 and the transmission PCM signal A 126 input into the I/F converting unit A120 via and the selector 122 are transmission PCM data. The transmission PCM data and the reception PCM data are transmitted with the clock CLK and the synchronization signal FSYNC of the modem A output synchronization signal 131 as timing signals.

Next, explanation will be given for a case in which a PCM data transfer is performed by the modem B108 and the I/F converting unit B121.

The reception PCM signal B135 output from the I/F converting unit B121 and input into the modem B108 is reception PCM data. In addition the modem B transmission PCM signal 134, and the transmission PCM signal B129 input into the I/F converting unit B121 via the selector 139 are transmission PCM data. The transmission PCM data and the reception PCM data is transmitted with the clock CLK and the synchronization signal FSYNC of the modem B output synchronization signal 132 as timing signals.

Next, explanation will be given for a case in which a PCM data transfer is performed by the SLIC 109 and the I/F converting unit A120.

The reception PCM signal A123 output from the I/F converting unit A120 and the SLIC reception PCM signal 124 input into the SLIC 109 via the selector 112 are reception PCM data. Also the SLIC transmission PCM signal 130 output from the SLIC 109, and the transmission PCM signal A 126 input into the I/F converting unit A120 via the selector 122 are transmission PCM data. The transmission PCM data and the reception PCM data are transmitted with the clock CLK and the synchronization signal FSYNC of the modem A output synchronization signal 131 as timing signals.

Next, explanation will be given for a case in which a PCM data transfer is performed by the SLIC 109 and the I/F converting unit B121.

The reception PCM signal B135 output from the I/F converting unit B121, and the SLIC reception PCM signal 124 input into the SLIC 109 via the selector 112 are reception PCM data. In addition, the SLIC transmission PCM signal 130 output from the SLIC 109, and the transmission PCM signal B129 input into the I/F converting unit B121 via the selector 139 are transmission PCM data. The transmission PCM data and the reception PCM data are transmitted with the clock CLK and the synchronization signal FSYNC of the modem B output synchronization signal 132 as timing signals.

This means that timing is taken with the rising edge of the synchronization signal FSYNC, and over eight clock cycles continuing from the rising edge of the clock CLK, the transmission PCM data and the reception PCM data are enabled.

In this embodiment, an output side of the transmission PCM data of the I/F converting units and modems performing data transfer with each other, outputs data on the rising edge of the clock CLK, and an input side receives the data on the falling edge of the clock CLK. In addition, the output side of the reception PCM data of the modems and the I/F converting units performing data transfer with each other outputs data on the rising edge of the clock CLK, and the input side receives data on the falling edge of the clock CLK. Also, the SLIC and the I/F converting units performing data transfer with each other perform data transfer similarly.

In this way, by performing data transfer of PCM data supplying the SLIC, the I/F converting units, or the like, with the same clock CLK and synchronization signal FSYNC from the modem, data can be synchronized, and it is possible to eliminate a temporal misalignment of audio data. Note, in the PCM data transfer, it is possible to employ an appropriate serial communication mode other than SPI, SSI or the like. Note, if it is a mode for synchronizing of a PCM data transfer supplying the same clock CLK from the modem to the SLIC, the I/F converting unit, or the like, limitation is not made to the timing explained above.

The I/F converting unit C110, in order to adapt the modem A107, the modem B108, and the control data signal of the SLIC 109 to the bus 111, and perform transmission and receiving of control data, performs an interface conversion. The modem A107 and the I/F converting unit C110 are connected by a control data signal 136, and control commands from the CPU 102, response statuses, transmitted and received data, or the like, are transmitted. Similarly, the modem B108 and the I/F converting unit C110 are connected by a control data signal 138. Similarly, the SLIC 109 and the I/F converting unit C110 are connected by a control data signal 137. The control data signals 136-138 are electric signals by UART, SPI, I2C or some other appropriate serial mode.

The modem A107 and the modem B108 retrieve data by demodulating an audio signal, and based on that data, generate a modulated audio signal. Upon reception, a modem converts PCM data which is a digital signal of a voice frequency band of the G.711 format, or the like, received by an audio coding/decoding electric circuit (audio CODEC) integrated in that modem, into an audio signal. The modem transfers data obtained by detecting a tone signal included in the audio signal, a procedure signal, an image signal, or the like, and demodulating to the CPU 102 via the I/F converting unit C110. Data obtained in this way is stored in the RAM 105, and using this, the CPU 102 performs communication control of a FAX, printing, or the like.

At the time of transmission the CPU 102 supplies encoded image data to a modem via the I/F converting unit C110, and generates an audio signal by modulating with that modem. Then, the modem converts PCM data which is a digital signal of a voice frequency band of the G.711 format, or the like, received by an audio coding/decoding electric circuit (audio CODEC) integrated into that modem, and transmits via the I/F converting unit A120, the I/F converting unit B121, or the like. In addition, audio, a tone, DTMF, or the like, is transmitted by PCM data in accordance with a control command transmitted to a modem via an I/F converting unit C110 from the CPU 102.

The SLIC 109 includes integrally within the same chip an analog-digital conversion electric circuit (A/D), a digital-analog conversion electric circuit (D/A), a digital signal processor (DSP), and a voice coding decoding circuit (audio CODEC). The SLIC 109 is an abbreviation of Subscriber Line Interface Circuit. The SLIC 109 performs A/D conversion on audio input from a microphone of the slave telephone apparatus 128, performs signal processing with the DSP, converts into PCM data of the G.711 format, or another type of encoded data with an audio CODEC, and after this transmits to the IP network 151. Also, the SLIC 109 decodes the PCM data of the G.711 format received from the IP network 151, or another type of is encoded data with an audio CODEC, performs signal processing with the DSP, performs D/A conversion, and transmits to the slave telephone apparatus 128. With this, audio is output from the speaker of the slave telephone apparatus 128. The SLIC 109 controls the slave telephone apparatus 128 for the PSTN off-hook detection of the slave telephone apparatus 128, direct current application, call signal output

In this embodiment, what is called the SLIC 109 includes externally attached electric circuits necessary for off-hook detection, direct current application, the output of the call signal, and the like. In addition, the SLIC 109 is able to perform tone detection, pulse detection, or the like, and is able to detect destination address specification signals for calling. Also, the SLIC 109 has a function for generating various tone signals. By the SLIC 109 it is possible to connect an analog telephone apparatus to the IP network 151 without going through a telephone line of the PSTN.

The slave telephone apparatus 128 is connected to the SLIC 109 by an interface for the PSTN. A microphone and a speaker are built in to the slave telephone apparatus 128, audio data of a partner is output from the speaker, audio of the user is input from the microphone, and the user uses the slave telephone apparatus 128 for calling. In a case where the slave telephone apparatus 128 has an answering machine function the MFP 101 can be used setting an away TEL connection mode. The answering machine function is a function for recording audio data of a partner to the slave telephone apparatus 128 when the user is absent.

In addition, the MFP 101 has a function of a T.38 supporting FAX, and FAX communication in accordance with T.38 is possible by connecting with the partner T.38 supporting FAX 155 via the IP network 151. The user makes an NGN contract with a telephone company, and receives an assignment of a telephone number based on a numbering plan. Then, by the setting of the analog port included router 156, the telephone number “03-0000-0005” can be allocated for the MFP 101, and communication can be performed. The MFP 101 is able to perform a call connection with a communication partner by SIP.

Next, explanation will be given for a flow of data upon performance of FAX communication by T.38.

The CPU 102 converts image data obtained by the scanner 118 scanning into encoded data such as JBIG data, or the like, using the image processing unit 103. Then, this encoded data converts into data of a format suitable for T.38 with the network I/F control unit 119, and transfers to the IP network 151 via the analog port included router 156. Then, a T.38 IP packet reaches the T.38 supporting FAX 155 of the partner device. In addition, the T.38 IP packet transmitted from the T.38 supporting FAX 155 reaches the network I/F control unit 119 via the IP network 151 and the router 156, and encoded digital image data is retrieved and transmitted to the CPU 102. In this way digital image data encoded into JBIG, or the like, is decoded into raw image data, output to the printer I/F control unit 115 as received data and printed on the printer 116.

In addition, in a case where the communication partner does not support T.38, the MFP 101 can perform a G3 FAX communication by “treated as audio communication”. In this embodiment, the user makes an NGN contract with a telephone company, and by performing “treated as audio communication” with the same telephone number “03-0000-0005” as the MFP 101, i.e. performing G3 FAX communication using a modem. It is also possible to make a contract with a telephone company, and be assigned a new telephone number based on a numbering plan for “treated as audio communication”. Explanation will be given for the data flow in such a case.

The CPU 102 converts image data, obtained by the scanner 118 scanning, into encoded data such as JBIG data. The CPU 102 modulates the encoded digital image data with a modem, and converts into PCM digital audio data of the G.711 format or of another encoding type. Then the CPU 102 converts the digital audio data into VoIP packets, and transmits to the IP network 151 via the network I/F control unit 119, and the analog port included router 156. The VoIP packets are in accordance with RTP (Real-time Transport Protocol).

Also, the VoIP GW (gateway) 152, which performs data transfer processing between the IP network 151 and the PSTN network 153 exists. The VoIP GW 152 converts VoIP data into a format capable of passing through the PSTN 153, and “treated as audio communication” reaches the G3 FAX 158 of the partner device via the PSTN 153. In addition, an audio signal transmitted from the G3 FAX 158 via the PSTN 153 is converted into VoIP data by the VoIP GW 152, and reaches the network I/F control unit 119 via the IP network 151, and the analog port included router 156. VoIP data that arrives in this way is sent to the CPU 102 via the bus 111, and the G.711 format PCM data is retrieved. Then, the obtained PCM data is sent to the modem A107 via the I/F converting unit A120 and demodulated, encoded digital image data is retrieved and sent to the CPU 102. After this, the CPU 102 decodes the digital image data encoded into JBIG, or the like, into raw image data with the image processing unit 103, outputs it to the printer I/F control unit 115 as received data, and prints with the printer 116.

In addition, calling the partner telephone apparatuses 159 and 161 via the IP network 151 is possible using the slave telephone apparatus 128 connected to the MFP 101 and the SLIC 109. In this embodiment, the same telephone number “03-0000-0005” as with the above described “treated as audio communication” is used by the slave telephone apparatus 128 as well. However, it is also possible to make a contract with a telephone company, and be assigned a new telephone number based on a numbering plan for slave telephone audio.

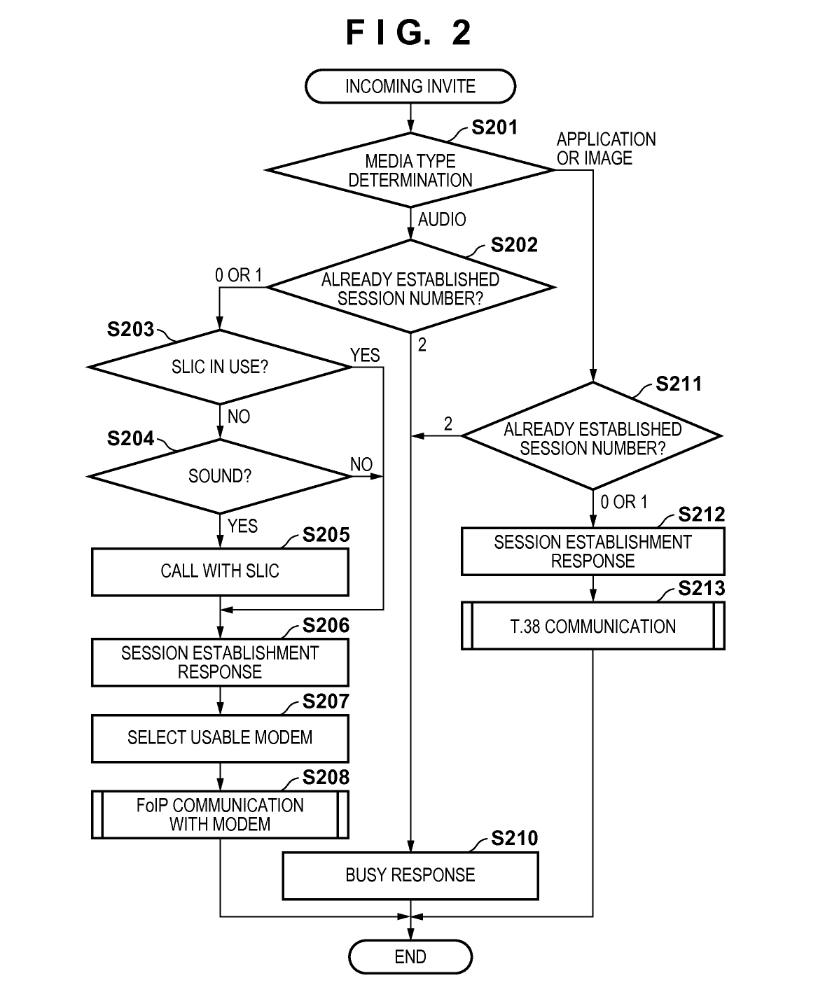

FIG. 2 is a flowchart for describing automatic reception processing in the MFP according to a first embodiment. A program for executing this processing is stored in the ROM 104 or the HDD 106, and loaded into the RAM 105 upon execution, and by the CPU 102 executing this program, the processing shown in this flowchart is executed. Note, this program is divided into tasks for each session, and is executed by the CPU 102 upon the receipt of an INVITE signal by a task. Prior to the initiation of this processing, the MFP 101 is in a standby state, and the state is such that the user is able to perform an operation of his or her choice.

When an INVITE signal is received, the CPU 102, in step S201, receives the INVITE signal from the network I/F control unit 119 and determines a media type specified by the INVITE signal. Here, in a case where it is determined that the media is audio, the processing proceeds to step S202, and the CPU 102 determines the number of already established sessions. Here, since session establishment is possible if the number of already established sessions is one or less, the processing proceeds to step S203 from step S202, and the CPU 102 determines whether or not the SLIC 109 is in use. Note, the CPU 102 saves, in the RAM 105, status information indicating that the SLIC 109 is in an in use state when using the SLIC 109 through the control data signal 137 output from the I/F converting unit C110. Then, when the CPU 102 finishes using the SLIC 109, it updates the status information saved in the RAM 105 so as to indicate that the SLIC 109 is unused. With this, the CPU 102 can determine whether or not the SLIC 109 is in use by referencing the status information stored in the RAM 105 in step S203.

In a case where the CPU 102 determines that the SLIC 109 is not in use in step S203, the processing proceeds to step S204, and a sounding setting of the MFP 101 is determined. In an automatic reception receiving mode, fax reception is performed by the MFP 101 automatically responding upon an incoming call. The MFP 101 is able to set sounding/non-sounding upon an incoming call, and in a case in which a sounding setting has been made, even in the automatic reception mode, configuration is such that the telephone apparatus is sounded a number of times in order to notify the user of the incoming call. Accordingly, when the CPU 102 determines that the sounding setting is set, in step S204, the processing proceeds to step S205, a call signal is generated by the SLIC 109 through the control data signal 137 from the I/F control unit C110, and the slave telephone apparatus 128 which is connected to the SLIC 109 is sounded a predefined number of times. After this, the processing proceeds to step S206, and a session establishment response is performed. With this, (200 OK) is transmitted to the LAN 157 through the network I/F control unit 119.

On the other hand, when, in step S204, the CPU 102 determines that non-sounding is set, step S205 is skipped, and the processing proceeds to step S206. In addition, in a case where the CPU 102 determines that the SLIC 109 is in use in the SLIC 109 in use determination of step S203, the processing proceeds to step S206 without performing the processing of a telephone call of step S205, and a session establishment response is performed. This is because the receiving mode is automatic reception, and configuration is taken such that even in a case where the slave telephone apparatus 128 is not sounded, a session can be established.

After this, the CPU 102 moves the processing to from step S206 to step S207, and selects a usable modem. Regarding the selection processing of step S207, a status variable indicating a usage status of the modem A107 and the modem B108 is saved in the RAM 105 in advance, that status variable is read out, and a modem not being used is selected. Here, the status information of the selected modem is updated at the same time. When a usable modem is selected in this way in step S207, the processing proceeds to step S208, and the CPU 102 initiates FoIP (FAX over Internet Protocol) communication using the selected modem. Here, FoIP is “treated as audio communication”, in which modem signal tones are treated as audio, converted to PCM data, and communication of them as audio packets is performed over the IP network 151. Here, in accordance with the modem selected in step S207, the CPU 102 controls so that the selector 122 or the selector 139 is switched, and data that the modem transmits flows to the I/F converting unit. In addition, because the SLIC 109 is not used upon FoIP communication, the CPU 102 controls such that modem synchronization signals do not flow to the SLIC 109 by switching the selector 127, and status information of the SLIC 109 saved in the RAM 105 is updated.

On the other hand, in a case where the CPU 102 determines that the media type is application or image in the determination of the media type in step S201, T.38 communication is performed without sounding the slave telephone apparatus 128. In such a case, firstly the processing proceeds to step S211, the number of sessions that are already established is determined, and if the number of already established session is one or less, the processing proceeds to step S212, and the CPU 102 performs a session establishment response. Then, the CPU 102 moves the processing to step S213, and initiates the T.38 communication.

Note, in a case where the CPU 102 determines that the number of the already established sessions is “2” in step S202 or step S211, the processing proceeds to step S210, and because no more sessions can be generated, a busy response is transmitted to the LAN 157 through the network I/F control unit 119.

As explained above, by virtue of the processing shown in the flowchart of FIG. 2, when an INVITE signal for which the media type is application or image is received, if the number of already established sessions is within a predetermined number, T.38 communication can be initiated.

In addition, when an INVITE signal for which the media type is audio is received, if the number of already established sessions is within a predetermined number, the receiving mode can be switched for incoming call operation in accordance with a usage state of an SLIC. Also, in a case where the number of already established sessions exceeds a predetermined number, a busy response is made.

In addition, in a case where the receiving mode is automatic reception, if an INVITE signal for which the media type is audio is received, and the number of already established sessions is within a predetermined number, automatic reception is performed on a usable modem after performing a slave telephone call in accordance with the sounding setting when the SLIC is useable. In addition, if the SLIC is not usable, automatic reception can be performed with a usable modem without calling the slave telephone.

With this, in a case of automatic reception when an INVITE signal for which the media type is audio is received when the number of sessions that are established is zero or one, FoIP communication in a case where a partner is a FAX becomes possible.

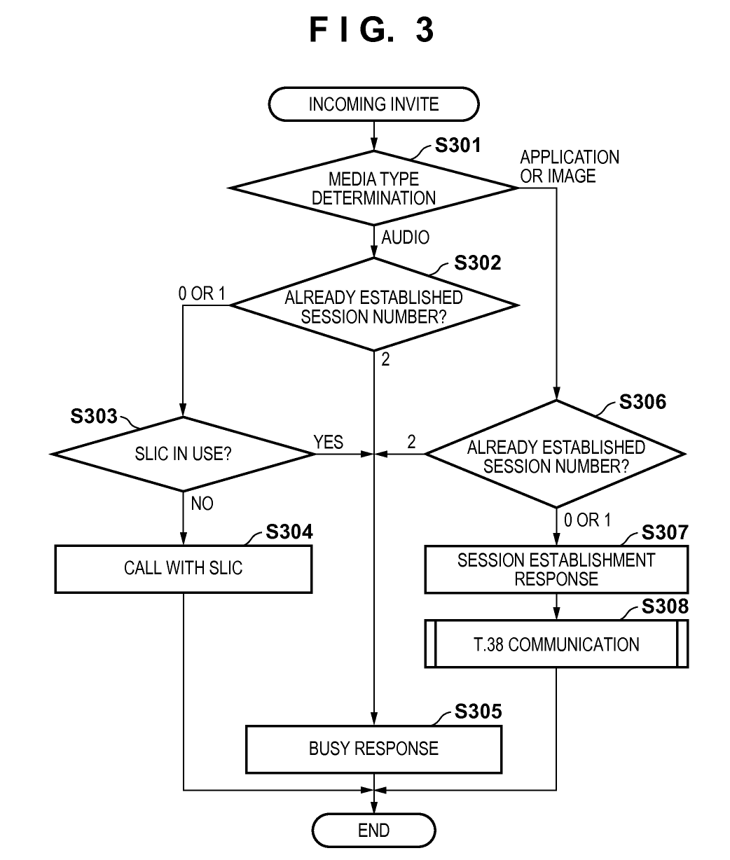

Next, FIG. 3 is a flowchart for describing manual reception processing in the MFP according to the first embodiment. A program for executing this processing is stored in the ROM 104 or the HDD 106, and loaded into the RAM 105 upon execution, and by the CPU 102 executing this program, the processing shown in this flowchart is executed. Note, this program is divided into tasks for each session, and is executed by the CPU 102 upon the receipt of an INVITE signal by a task. Prior to the initiation of this processing, the MFP 101 is in a standby state, and the state is such that the user is able to perform an operation of his or her choice.

When an INVITE signal is received, the CPU 102, in step S301, receives the INVITE signal from the network I/F control unit 119 and determines a media type specified by the INVITE signal. Here, in a case where the CPU 102 determines that the media is audio, the processing proceeds to step S302, and the CPU 102 determines the number of already established sessions. When it is determined that the number of already established sessions is one or less, the processing proceeds to step S303, and the CPU 102 determines whether or not the SLIC 109 is in use. This determination is executed similarly to that of step S203 of FIG. 2. When, in step S303, the CPU 102 determines that the SLIC 109 is not in use, it moves the processing to step S304. In step S304, the CPU 102 generates a call signal by controlling the SLIC 109 with the control data signal 137 from the I/F control unit C110, sounds the connected slave telephone apparatus 128, and the processing completes.

On the other hand, in a case where the CPU 102 determines that the SLIC 109 is in use in step S303, the processing proceeds to step S305, and a busy response is transmitted to the LAN 157 through the network I/F control unit 119. This is because the receiving mode is manual reception mode, and configuration is taken such that if calling the user with the slave telephone apparatus 128 is not possible, session establishment is not performed.

In addition, in a case where the CPU 102 determines that the media type is application or image in the determination of the media type in step S301, T.38 communication is performed without sounding the slave telephone apparatus 128. In such a case, firstly the processing proceeds to step S306, the CPU 102 determines the number of already established sessions, and if the number of already established session is one or less, the processing proceeds to step S307. In step S307, the CPU 102 performs a session establishment response, the processing proceeds to step S308, and T.38 communication is initiated.

Note, in a case where the CPU 102 determines that the number of the already established sessions is “2” in step S302 or step S306, the processing proceeds to step S305, and because no more sessions can be generated, the CPU 102 transmits a busy response to the LAN 157 through the network I/F control unit 119.

As explained above, by virtue of the processing shown in the flowchart of FIG. 3, when an INVITE signal for which the media type is audio is received upon a manual reception, if the number of established sessions is within a predetermined number, calling of a telephone by an SLIC if the SLIC is not in use can be performed. In addition, when an INVITE message for which the media type is application or image is received upon a manual reception, if the number of established sessions is within a predetermined number, it is possible to perform communication by establishing a session.

With this, in a case in which a partner has a call objective when an INVITE signal for which the media type is audio is received when the number of sessions that are established is zero or one, if manual reception, the session establishment is not performed in the situation in which the slave telephone apparatus is not usable. With this, it is possible to avoid the occurrence of needless charges.

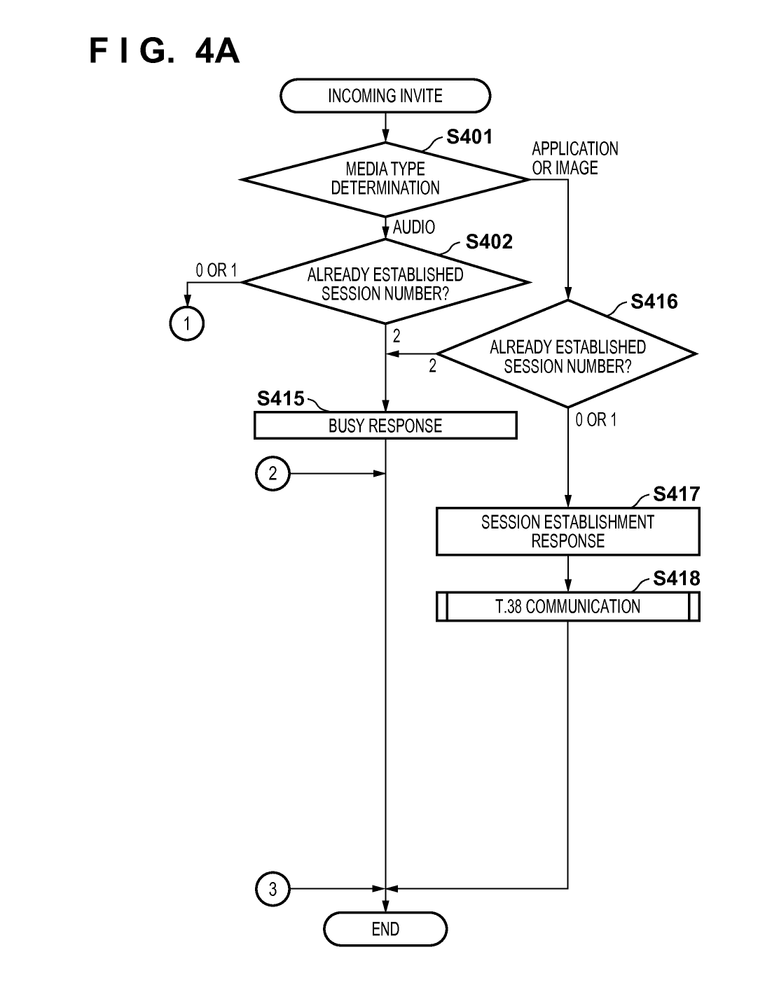

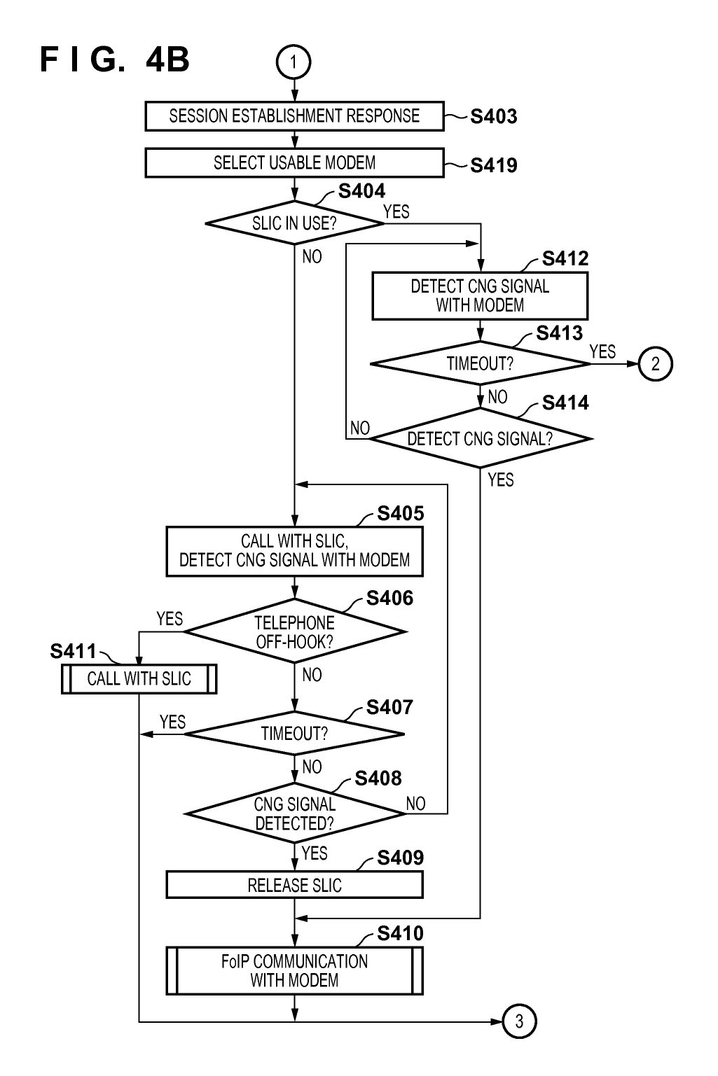

Next explanation will be given for a flow of FAX/TEL switching using FIGS. 4A and 4B.

FIGS. 4A and 4B are a flowchart for describing FAX/telephone switching processing in the MFP according to the first embodiment. A program for executing this processing is stored in the ROM 104 or the HDD 106, and loaded into the RAM 105 upon execution, and by the CPU 102 executing this program, the processing shown in this flowchart is executed. Note, this program is divided into tasks for each session, and is executed by the CPU 102 upon the receipt of an INVITE signal by a task. First, the MFP 101 is in a standby state, and the state is such that the user is able to perform an operation of his or her choice.

This processing is initiated upon the receipt of an INVITE signal from the network I/F control unit 119 by the CPU 102, and firstly, the CPU 102, in step S401, determines a media type specified by the INVITE signal. In a case where the CPU 102 determines that the media type is audio in step S401, the processing proceeds to step S402, and the CPU 102 determines the number of already established sessions. Here, when it is determined that the already established sessions are one or less, the processing proceeds to step S403, and a session establishment response is transmitted to the LAN 157 through the network I/F control unit 119.

After that, the processing proceeds to step S419, and the CPU 102 selects a usable modem. The approach for selecting the modem here is similar to that of the case of step S207 in FIG. 2. Next, the processing proceeds to step S404, and the CPU 102 determines whether or not the SLIC 109 is in use. The determination approach in such a case is the same as in the case of step S203 in the previously described FIG. 2. In a case where the CPU 102 determines that the SLIC 109 is not in use in step S404, the processing proceeds to step S405, and the CPU 102 generates a call signal with the SLIC 109 through the control data signal 137 from the I/F control unit C110, and sounds the connected slave telephone apparatus 128. Simultaneously, using the modem selected in step S419, detection of a CNG signal is initiated. In addition, in order to indicate to the transmitter that the slave telephone apparatus is in the process of being called, OGM audio data is read out from the RAM 105, converted into PCM data by the selected modem, and transmitted to the LAN 157 through the network I/F control unit 119. While a CNG signal is not detected after the OGM audio data is sent, pseudo RBT (Ring Back Tone) PCM data is generated with the modem in steps S405-S408, and transmitted to the LAN 157 through the network I/F control unit 119.

During processing of steps S405-S408, an elapsed time is monitored by a timer, and when a timeout is detected in step S407, the CPU 102 interrupts and ends the processing. In addition, in a case where the CPU 102 detects an off-hook of the slave telephone apparatus 128 through the I/F converting unit C110 in step S406, the CPU 102 moves the processing to step S411, and in accordance with the modem selected in step S419, and switches the selector 122 (or the selector 139). With this, the modem is disconnected and control is performed to communicate by the SLIC 109.

In addition, in a case where the CPU 102 determines that the CNG signal is detected by the modem in step S408, the processing proceeds to step S409, and the CPU 102 switches the selector 122 or the selector 139 in accordance with the modem selected in step S419. With this, data that the modem transmitted is supplied to the I/F converting unit A120 or the I/F converting unit B121. In addition, because the SLIC 109 is not used upon FoIP communication, a synchronization signal of the modem is controlled so as not to flow to the SLIC 109 by switching the selector 127. Then status information of the SLIC saved in the RAM 105 is updated to a suspended status. Then, the processing proceeds to step S410, and the CPU 102 performs FoIP communication using the modem are selected in step S419.

On the other hand, in a case where the CPU 102 determines that the SLIC 109 is in use in step S404, it moves the processing to step S412, and the CPU 102 initiates detection of the CNG signal by the modem selected in step S419 without sounding the slave telephone apparatus 128. In addition, if this is a FAX, after reading out OGM data from the RAM 105 and converting it into PCM data with the modem, transmission is performed to the LAN 157 through the network I/F control unit 119 in order to notify the transmitter that receiving is possible. OGM audio such as, “I cannot answer the telephone right now, please transmit a facsimile” is used. Then, the processing proceeds to step S413, and the processing of steps S412-S414 is executed until a timeout is detected by the timer, or until the modem detects a CNG signal. When the CPU 102 detects a timeout in step S413, it interrupts and ends this processing.

In addition, in a case where the CPU 102 determines that the CNG signal is detected by the modem in step S414, the processing proceeds to step S410, and the CPU 102 performs FoIP communication using the modem selected in step S419.

Meanwhile, in a case where the CPU 102 determines that the media type is application or image in step S401, the processing proceeds to step S416, and the CPU 102 performs T.38 communication without sounding the slave telephone apparatus 128. In such a case, firstly, in step S416, the CPU 102 determines the number of already established sessions, and if the number is one or less, the processing proceeds to step S417, and a session establishment response is performed, and T.38 communication is initiated in step S418.

Note, in a case where it is determined that the number of already established sessions is two in step S402 or step S416, because no more sessions can be generated, the CPU 102 transmits a busy response through the network I/F control unit 119 to the LAN 157, and the processing completes.

According to the processing shown in this flowchart, in a case where the receiving mode is FAX/TEL switching, if the SLIC is useable, FAX/TEL switching processing can be performed using the SLIC and a usable modem after calling the slave telephone apparatus 128 in accordance with the sounding setting. In addition, in a case where the SLIC is not usable, FAX/TEL switching processing can be performed by a usable modem.

According to the processing of FIGS. 4A and 4B, in a case of FAX/TEL switching, FoIP communication can be executed when the partner is a FAX. Because of this, it is not necessary to return a busy response.

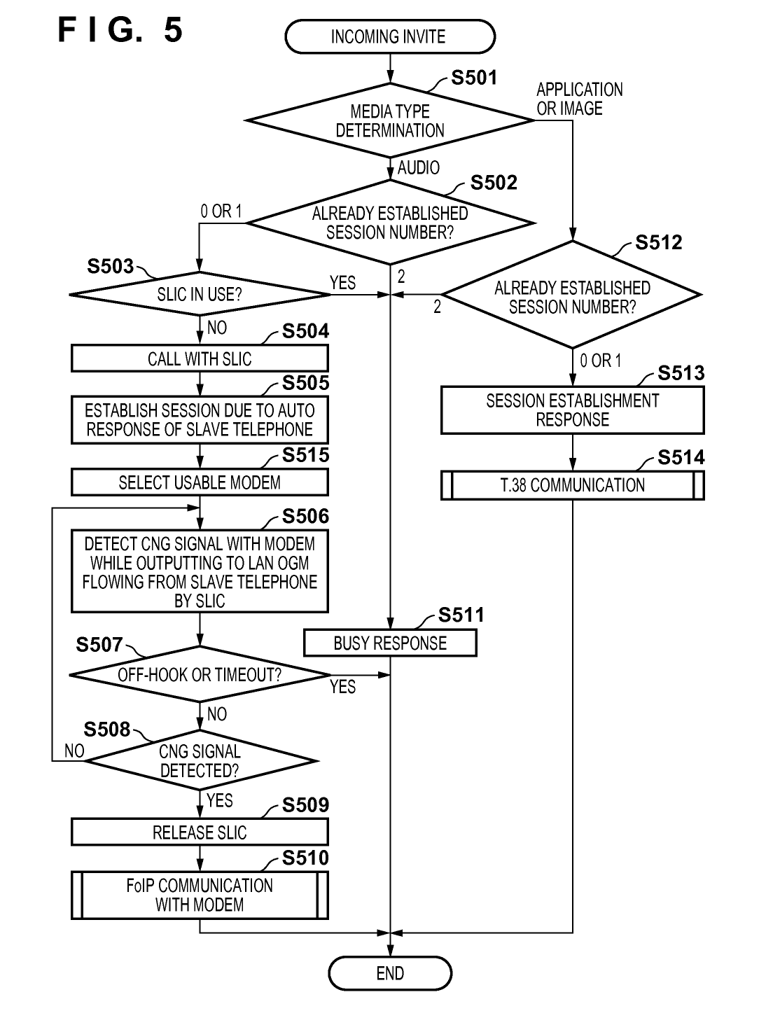

Next, explanation will be given of an answering machine connection flow with reference to FIG. 5.

FIG. 5 is a flowchart for describing reception processing in a case where a receiving mode of the MFP according to the first embodiment is a mode for connecting to an answering machine. A program for executing this processing is stored in the ROM 104 or the HDD 106, and loaded into the RAM 105 upon execution, and by the CPU 102 executing this program, the processing shown in this flowchart is executed. Note, this program is divided into tasks for each session, and is executed by the CPU 102 upon the receipt of an INVITE signal by a task. First, the MFP 101 is in a standby state, and the state is such that the user is able to perform an operation of his or her choice.

This processing is initiated upon the receipt of an INVITE signal from the network I/F control unit 119 by the CPU 102, and firstly, the CPU 102, in step S501, determines a media type specified by the INVITE signal. Here, in step S501, the CPU 102 determines that the media type is audio, the processing proceeds to step S502, and the CPU 102 determines the number of already established sessions. When it is determined that the number of already established sessions is one or less, the processing proceeds to step S503, and the CPU 102 determines whether or not the SLIC 109 is in use. This determination approach is the same as that of step S203 of FIG. 2. In a case where the CPU 102 determines that the SLIC 109 is not in use in step S503, the processing proceeds to step S504, and the CPU 102 generates a call signal with the SLIC 109 through the control data signal 137 from the I/F control unit C110, and sounds the connected slave telephone apparatus 128. After that, when the CPU 102 detects an off-hook due to an automatic response of the slave telephone apparatus 128, a session establishment response is transmitted to the LAN 157 through the network I/F control unit 119 in step S505.

Next, the processing proceeds to step S515, and the CPU 102 selects a usable modem. This approach for selecting is the same as in the case of step S207 of FIG. 2. After that, the processing proceeds to step S506, and the CPU 102 transmits to the LAN 157 the OGM that the slave telephone apparatus 128 outputs through the SLIC 109 while performing detection of the CNG signal using the modem selected in step S515. Then, in steps S507-S508, it is determined whether or not a timeout by the timer or the CNG signal is detected. When, a timeout is detected in step S507, the processing completes. In addition, when the CPU 102 determines that the CNG signal is detected in step S508, it moves the processing to step S509. In step S509, the CPU 102 controls so that the selector 122 or the selector 139 is switched in accordance with the modem selected in step S515, and data that the modem transmits flows to the I/F converting unit A or B. In addition, because the SLIC 109 is not used upon FoIP communication, control is made so that the synchronization signal of the modem does not flow to the SLIC 109 by switching the selector 127. Also, the status information of the SLIC saved in the RAM 105 is updated to suspended here. After this, the processing proceeds to step S510, the CPU 102 initiates FoIP communication using the modem selected in step S515, and the processing completes.

Note, in a case where it is determined that the SLIC 109 is in use in step S503, the processing proceeds to step S511, and the CPU 102 transmits a busy response to the LAN 157 through the network I/F control unit 119. This is because the receiving mode is away TEL connection, and configuration is taken such that if the slave telephone apparatus 128 cannot be called, session establishment is not performed.

In addition, in a case where it is determined that the media type is application or image in the determination of the media type in step S501, T.38 communication is performed without sounding the slave telephone apparatus 128. In such a case, firstly, the processing proceeds to step S512, and the CPU 102 determines the number of already established sessions, and if the number is one or less, the processing proceeds to step S513, and session establishment response is performed, and T.38 communication is initiated in step S514.

Note, in a case where the CPU 102 determines that the number of already established sessions is two in step S502 or in step S512, because no more sessions can be generated, it moves the processing to step S511. In step S511, the CPU 102 transmits a busy response to the LAN 157 through the network I/F control unit 119, and the processing completes.

By virtue of the processing shown FIG. 5, in a case where the receiving mode is answering machine connection, if the SLIC is useable, the slave telephone apparatus is called, and FAX/TEL switching processing is performed with the SLIC and a usable modem when it is detected that the slave telephone apparatus automatically responded. In a case where the SLIC is not usable, a busy response is made.

With this, in a case of an answering machine mode, it is possible that when the partner has a call objective, a session establishment is not performed in a situation where a slave telephone apparatus is not usable. With this, there is the effect that it is possible to avoid the occurrence of needless charges.

### Second Embodiment

Next, explanation will be given for a second embodiment of the present invention.

Explanation will be given for control added in a case in which, when FAX/TEL switching is performed, and FoIP communication is initiated as a result of the CNG signal being detected in an incoming audio call of a first session in the previously described the first embodiment, it is determined that it is not necessary to transmit PCM data from the SLIC 109. Even if it is not necessary to transmit PCM data from the SLIC 109, the SLIC 109 cannot be used in the second session as is.

Explanation will be given for the reason for this. It is assumed that the modem used for the detection of the CNG signal in an incoming call for which the media type is audio of a first session is the modem A107. In such a case, the modem A output synchronization signal 131, which includes the clock CLK output from the modem A107 and the synchronization signal FSYNC, is supplied to the I/F converting unit A120, and to the SLIC 109 via the selector 127. This state defines “making an output synchronization signal sharing relationship” of the clock CLK and the synchronization signal FSYNC with the modem A107, the SLIC 109, and the I/F converting unit A120.

In such a case, the modem used for the detection of the CNG signal in the incoming audio call of a subsequent second session will be the modem B108. Here, because the modem B108 and the I/F converting unit B121 make an output synchronization signal sharing relationship, problems in transmission timing for transmission and reception PCM data do not occur. However, because the SLIC 109 and the I/F converting unit B121 do not share the output synchronization signal, problems arise in transmission timing of transmission and reception PCM data between the SLIC 109 and the I/F converting unit B121. In such cases, the SLIC 109 attempts to transmit and receive PCM data with the output synchronization signal output from the modem A107 of the first session. For this reason, a setup and a hold timing corresponding to the clock CLK from the modem B108 are not satisfied, and PCM data cannot be transmitted correctly. For this reason, a new control mode is required.

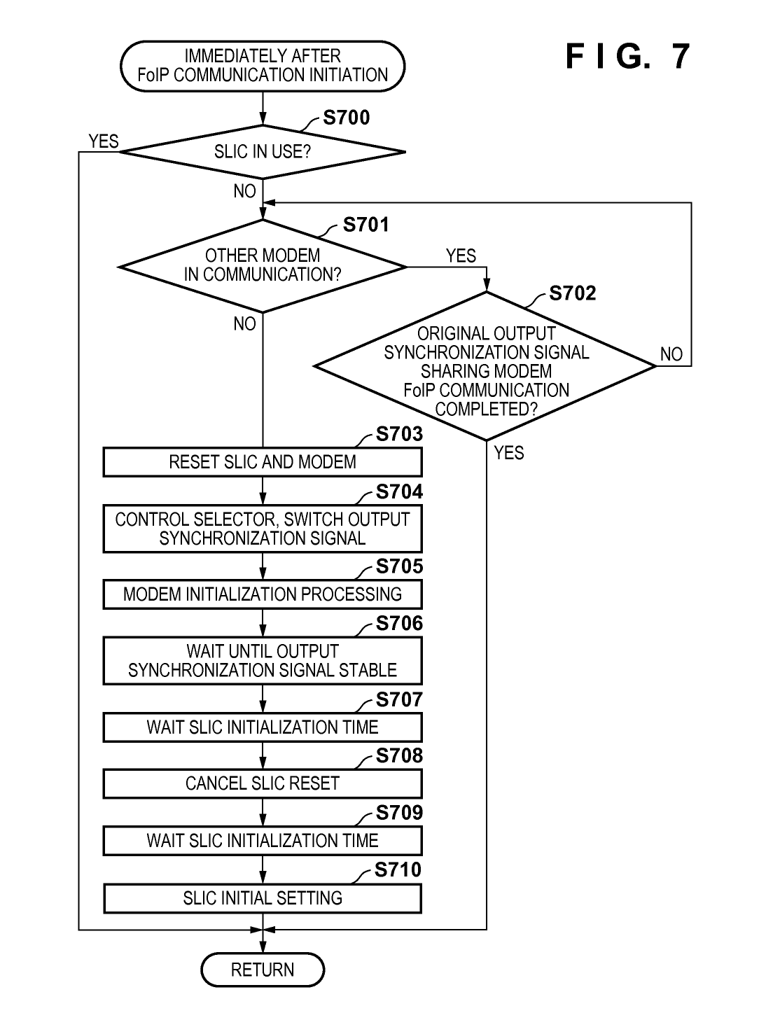

Control which is called separately immediately after the initiation of step S410, in the steps of the flowchart of FIGS. 4A and 4B used in the explanation of the previously described the first embodiment, is added as a new control mode. Here, the added control is executed as a different subroutine to the control shown in FIGS. 4A and 4B, and explanation will be given using the flowchart shown in FIG. 7.

FIG. 7 is a flowchart for describing processing of the subroutine executed immediately after initiation of FoIP communication of step S410 in the MFP according to a second embodiment. Note, the configuration of the MFP 101 according to the second embodiment and its communication network are the same as in the case of the previously described first embodiment, and so explanation is omitted.

Firstly, in step S700, the CPU 102 determines whether or not the SLIC 109 is in use. Here, when it is determined that it is in use, because an output synchronization signal sharing relationship between the other modem, the I/F converting unit, and the SLIC 109 cannot be made, the processing completes. When it is determined that the SLIC 109 is not in use in step S700, processing proceeds to step S701, the CPU 120 determines whether or not the other modem is in communication, and advances the processing to step S702 if it is in communication, and to step S703 if it is not in communication. In step S702, the CPU 102 determines whether or not FoIP communication of the modem originally sharing the output synchronization signal has completed, and if it has completed, the processing completes since the SLIC 109 once again becomes useable. On the other hand, when it is determined that FoIP communication has not completed, the processing returns to step S701.

In this example, in the processing of step S703 to step S710 which will be explained later, re-establishment of the output synchronization signal sharing relationship between the modem B108, for which communication is not in progress, the I/F converting unit B121, and the SLIC 109 is performed.

When communication is not in progress for the other modem (here, the modem B108), the processing proceeds to step S703, the CPU 102 dispatches a reset signal corresponding to the SLIC 109 and the modem B108, operation is stopped, and initialization is performed. Next, the processing proceeds to step S704, and the CPU 102 switches the output synchronization signal by controlling the selector. Here, by controlling the selector 127 with the selector control signal 143, switching is performed such that the modem B output synchronization signal 132 output from the modem B108 is output to the SLIC 109 from the selector 127 as the output synchronization signal 133. With this, the output synchronization signals of the clock CLK and the synchronization signal FSYNC, which had been supplied to the SLIC 109 from the modem A107 up until this point, will be supplied from the modem B108.

Next, the CPU 102 moves the processing to step S705, and performs initialization processing of the modem. Here, the modem B108 is reset by the control data signal 138, and after a time period necessary for that reset is awaited by a timer, the reset signal of the modem B108 is cancelled, and initial settings of the modem are written by the control data signal 138 from the I/F converting unit C110. Next, the processing proceeds to step S706, and the CPU 102 waits a time period necessary for the modem B output synchronization signal 132 that the modem B108 outputs to stabilize with a timer.

Next, the processing proceeds to step S707, and the CPU 102 resets the SLIC 109, and waits a time period necessary for the reset with a timer. Because there is a stipulation for a time span of the reset signal, this kind of processing is performed. Then, in step S708, the CPU 102 cancels the reset signal to the SLIC 109. Then, the CPU 102, in step S709, waits for a time period necessary for initialization of the SLIC 109 with the timer. Here, in a case where the SLIC 109 is provided with a clock multiplication electric circuit such as a PLL (Phase Locked Loop), and it is necessary for a time period to pass before the PLL lock comes into effect. When the initialization of the SLIC 109 completes in this way, the processing proceeds to step S710, and the CPU 102 performs initial setting of the SLIC 109 with the control data signal 137 from the I/F converting unit C110. In this way the re-establishment of the output synchronization signal sharing relationship between the modem B108, the I/F converting unit B121, and the SLIC 109 completes. After this, it becomes possible to transmit and receive PCM data with the modem B108 and the I/F converting unit B121, and the SLIC 109 and the I/F converting unit B121.

As a result of the CNG signal being detected in an incoming audio call of a first session, FoIP communication is initiated, and even in a case where it is determined that it is not necessary to transmit PCM data from the SLIC 109, it is possible to use the SLIC 109 in an incoming audio call of a second session.

In addition, in a case where the modem used for the detection of the CNG signal in an incoming audio call of a first session is the modem B108, and an output synchronization signal sharing relationship of the modem B108, the SLIC 109, and the I/F converting unit B121 is made, similar processing is performed. In this case, a reset signal corresponding to the SLIC 109 and the modem A107 is dispatched in step S703, the operation of the modem A107 and the SLIC 109 is stopped, and they are initialized. Then, by controlling the selector 127 in step S704, switching is performed such that the modem A output synchronization signal 131 output from the modem A107 is output from the selector 127 to the SLIC 109 as the output synchronization signal 133. Then, in step S705, the reset signal of the modem A107 is cancelled, and an initial setting of the modem A107 is written with the control data signal 136 from the I/F converting unit C110.

### Third Embodiment

Next, explanation will be given for a third embodiment. Note, the configuration of the MFP 101 according to the third embodiment and its communication network are the same as in the case of the previously described first embodiment, and so explanation is omitted.

Explanation will be given for control added to the case where it is determined that it is not necessary to transmit PCM data from the SLIC 109, when an away TEL connection is performed, as explained in the second embodiment, and FoIP communication is initiated as a result of the CNG signal being detected in an incoming audio call of a first session. Even if it is not necessary to transmit PCM data from the SLIC 109, the SLIC 109 cannot be used in the second session as is.

The reason for this, and the added control content, is the same as explained in the second embodiment. A subroutine, shown in FIG. 7, is called separately immediately after the initiation of step S510, in the steps of the flowchart of FIG. 5 used in the explanation of the first embodiment. Then, an output synchronization signal sharing relationship by the clock CLK and the synchronization signal FSYNC of a modem, the SLIC 109, and an I/F converting unit is re-established. By doing this, it is possible to use the SLIC 109 in an incoming audio call of a second session.

### Fourth Embodiment

Next, explanation will be given for a fourth embodiment. Note, the configuration of the MFP 101 according to the fourth embodiment and its communication network are the same as in the case of the previously described first embodiment, and so explanation is omitted.

Explanation will be given for control added to a case where, when an automatic reception is performed, after the telephone is called by the SLIC 109 in an incoming audio call of a first session, FoIP communication is initiated, and it is determined that it is not necessary to transmit PCM data from the SLIC 109. Even if it is not necessary to transmit PCM data from the SLIC 109, the SLIC 109 cannot be used in the second session as is. A case in which, after executing step S205, in the steps of the flowchart of FIG. 2 used in the explanation of the first embodiment, the user initiates FoIP communication in step S208 without using the slave telephone apparatus 128 applies.

The reason for this, and the added control content, is the same as explained in the second embodiment. A subroutine, shown in FIG. 7, is called separately immediately after the initiation of step S208, in the steps of the flowchart of FIG. 5. Then, an output synchronization signal sharing relationship by the clock CLK and the synchronization signal FSYNC of a modem, the SLIC 109, and an I/F converting unit is re-established. With this, it is possible to use the SLIC 109 in an incoming audio call of a second session.

Next, explanation will be given for a fifth embodiment. Note, the configuration of the MFP 101 according to the fifth embodiment and its communication network are the same as in the case of the previously described first embodiment, and so explanation is omitted.

Because in the control of the above described embodiments 2-4, the modem is reset in step S703 and in step S705, and initialization processing is performed, for this extra processing time is taken. Processing is optimized by omitting the initialization processing of the modem without resetting the modem. The processing other than that is the same as the control of the above described embodiments 2-4.

By virtue of these embodiments, an effect can be obtained as shown below when an audio INVITE signal is received for a second session.

(1) In a case of FAX/TEL switching, or in a case of an away TEL connection, as a result of the CNG being detected in an incoming audio call of a first session, FoIP communication is initiated, and in a case where it is determined that it is not necessary to transmit PCM data from a SLIC, it is possible to use the SLIC and process a call, an automatic response, or the like, of a slave telephone in a second session.
(2) In a case of an automatic reception, after a telephone is called by an SLIC in an incoming audio call of a first session, FoIP communication is initiated, and in a case where it is determined that it is not necessary to transmit PCM data from a SLIC, it is possible to use the SLIC and process a call, an automatic response, or the like, of a telephone in an incoming audio call of a second session.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-127985, filed Jun. 18, 2013, which is hereby incorporated by reference herein in its entirety.

1. An image communication apparatus capable of performing a call and a facsimile communication via an IP network, the apparatus comprising:
at least two modems;
an SLIC that connects a telephone apparatus;
a determination unit configured to determine whether or not an establishment of a session is possible when an INVITE signal, for which a media type is audio, is received; and
a control unit configured to control so that in an automatic reception mode, when the determination unit determines that the establishment of a session is possible, a usable modem is selected from out of the at least two modems, and treated as audio communication is performed using the selected modem;
so that when the determination unit determines that the establishment of a session is possible, it is determined whether or not the SLIC is in use, and when the SLIC is not in use, a call of the telephone apparatus is performed by the SLIC.

2. The image communication apparatus according to claim 1, wherein the control unit further controls so that in a manual reception mode, when the determination unit determines that the establishment of a session is possible, it is determined whether or not the SLIC is in use, and when the SLIC is not in use, a call of the telephone apparatus is performed by the SLIC, wherein if the SLIC is in use, a busy response is made.

3. The image communication apparatus according to claim 1, wherein the control unit further controls so that when a receiving mode is FAX/TEL switching, and the determination unit determines that the establishment of a session is possible, a usable modem is selected from out of the at least two modems, and when a CNG signal is detected by the selected modem, treated as audio communication is performed using that selected modem.

4. The image communication apparatus according to claim 3, wherein the control unit further controls so that it is determined whether or not the SLIC is in use, and when the SLIC is not in use a call of the telephone apparatus by the SLIC is performed, and controls so that if the SLIC is in use, the selected modem is caused to detect the CNG signal, and treated as audio communication is performed using the selected modem.

5. The image communication apparatus according to claim 1, wherein the control unit further controls so that in a case where a receiving mode is an answering machine mode, when the determination unit determines that the establishment of a session is possible, when the SLIC is not in use, when a call of the telephone apparatus is performed, and an automatic response of the telephone apparatus is detected, FAX/TEL switching processing is performed by the SLIC and a modem selected from the at least two modems, wherein if the SLIC is in use, a busy response is made.

6. The image communication apparatus according to claim 1, wherein the modem is a modem having a digital input/output function and built into which is a PCM codec.

7. The image communication apparatus according to claim 1, wherein the determination unit determines whether or not the establishment of a session is possible based on whether or not a number of sessions that are already established exceeds an upper limit value, and
the control unit makes a busy response when the determination unit determines that the establishment of a session is not possible.

8. The image communication apparatus according to claim 1, further comprising a first selector configured to supply the SLIC by selecting a single output synchronization signal output from one of the at least two modems;
a second selector for each of the at least two modems, each second selector configured to output by selecting either a transmission PCM signal output from a corresponding modem of the at least two modems or a transmission PCM signal output from the SLIC; and
a third selector configured to supply the SLIC by selecting one reception PCM signal input into one of the at least two modems, wherein
the control unit controls selection by the first, second and third selectors.

9. The image communication apparatus according to claim 8, wherein the control unit controls the first selector such that, in a case where FAX communication using one modem of the at least two modems is initiated, and the SLIC is not in use, it is determined whether communication is in progress for the other modem, of the at least two modems, which is not being used in the FAX communication, and if communication is not in progress for the other modem, an output synchronization signal sharing relationship is made between the other modem and the SLIC.

10. A method of controlling an image communication apparatus capable of performing a call and a facsimile communication via an IP network, and equipped with at least two modems and an SLIC that connects a telephone apparatus, the method comprising:
determining whether or not an establishment of a session is possible when an INVITE signal, for which a media type is audio, is received;
controlling so that in an automatic reception mode, when it is determined in the determining that the establishment of a session is possible, a usable modem is selected from out of the at least two modems, and treated as audio communication is performed using that selected modem, and
so that when it is determined in the determining that the establishment of a session is possible, it is determined whether or not the SLIC is in use, and when the SLIC is not in use, a call of the telephone apparatus is performed by the SLIC.

11. A non-transitory computer-readable storage medium storing a program for causing a computer to function as an image communication apparatus capable of performing a call and a facsimile communication via an IP network, the apparatus comprising:
at least two modems;
an SLIC that connects a telephone apparatus:
a determination unit configured to determine whether or not an establishment of a session is possible when an INVITE signal, for which a media type is audio, is received; and
a control unit configured to control so that in an automatic reception mode, when the determination unit determines that the establishment of a session is possible, a usable modem is selected from out of the at least two modems, and treated as audio communication is performed using the selected modem;
so that when the determination unit determines that the establishment of a session is possible, it is determined whether or not the SLIC is in use, and when the SLIC is not in use, a call of the telephone apparatus is performed by the SLIC.
